(19) United States
(12) Patent Application Publication
(10) Pub. No.: US 2020/0037779 A1
(43) Pub. Date: Feb. 6, 2020

(54) AREA SUPPORT SURFACE SEATING SYSTEM

(71) Applicant: Levy Zur, Boynton Beach, FL (US)

(72) Inventor: Levy Zur, Boynton Beach, FL (US)

(21) Appl. No.: 16/051,289

(22) Filed: Jul. 31, 2018

(51) Int. Cl. A47C 27/08; A61G 5/10; A47C 27/10

(52) U.S. Cl. CPC A47C 27/082; A47C 27/084; A47C 27/001; A47C 27/10; A61G 5/1045

(57) ABSTRACT

An area support surface seating system designed to optimize conditions that will avoid interrupting the healing procedure of pressure injuries in the area of the buttocks while an individual is placed in the seated position through the control of individual cells within the support surface to create a lower than capillary pressure site under an open wound and modulate external pressure over time on different regions of the buttocks to minimize secondary causes of pressure injuries. The area support surface also provides through its operation the means to restrain the progress of spinal deformities.

### BACKGROUND OF THE INVENTION

The present disclosure relates to an area support surface having a mode of operation to optimize conditions to avoid interrupting the healing of pressure injuries in the area of the buttocks while an individual is placed in the seated position through control of individual cells within the support surface to modulate external pressure over time on different regions of the buttocks. The area support surface also provides through its operation a means to restrain the progress of spinal deformities.

External pressure applied to bony parts of the human body may disrupt the blood flow through the capillaries and, when prolonged, may lead to the formation of pressure injuries. Generally, the higher the external pressure applied to the capillaries against bony parts of the body, the shorter the time required for a pressure sore to develop. Individuals with mobility impairments that prevent independent repositioning are at the highest risk for developing pressure ulcers.

Healthy people with good motor skills and sensory abilities instinctively move and shift weight while seated or lying in bed, and do so even while asleep. Such movements prevent prolonged application of pressure to any one site on the individual's body. People with poor motor skills and sensitivity disorders, such as the frail elderly and people with severe disabilities may not be able to sense pain or perform frequent weight relief essential for disrupting the capillary occlusion that leads to the creation of pressure sores without the assistance of another person.

It is commonly accepted among scholars and investigators that 32 mmHg is the threshold for capillary pressure. Higher external pressure over bony parts of the body may cause interruption of the blood supply to the correspondent cells resulting in loss of circulation and tissue necrosis. Early studies teach that certain parts of the body, such as the coccyx (tail bone) can bear much lower external pressure before breakdown of the skin. Aging and illness may reduce significantly the threshold of 32 mmHg.

Prolonged bed rest carries medical risks that affect cardiovascular, hematological and respiratory systems and have negative impact on the muscular and skeletal systems of the human body. Upright position during part of the day is essential for the human being. The seated position, however, raises several difficulties that are unique to problems caused by an immobile patient in the supine position.

While hospital mattresses and wheelchair cushions are both classified as support surfaces, there is a vast dissimilarity between them. The mattress, which may be referred to as a “full support surface,” covers approximately 1,800 square inches. A standard wheelchair cushion measuring 16 inches×18 inches, which may be referred to as an “area support surface,” covers 288 square inches. As a result, such a standard wheelchair cushion provides about 16% of the support area as a mattress to support approximately 70% of the body's weight in the seated position. Thus, the average pressure applied at each point of the cushion will often be 4 to 5 times higher than the pressure applied by the body on a mattress. Furthermore, while the standard hospital mattress is at least 5 inches deep (i.e., thickness), the wheelchair cushion is limited to 3 inches deep at the most. In the instance of a powered cushion, this depth allows 2.5 inch high air cells. These conditions create a high risk of bottoming out in the seated position on area support surfaces, which is a minimal or non-existent risk in full support surfaces.

The seated position as opposed to the supine position presents yet another set of particular problems needed to be addressed. The two ischials are 1.5 inches lower than the femurs and as long as no action is taken, they bear the entire pressure created by the upper body in the seated position. Since this position creates a very unstable situation for the already frail body supported by the cushion, maintaining sidewise equilibrium is of utmost importance in the seated position. Also, if the body slides forward, then the coccyx becomes the third bony part of support at very high risk of formation of pressure injury.

Thus, the risk of developing pressure sore at an ischial tuberosity or coccyx site while seated is much higher than developing a pressure injury anywhere else in the body in the supine position. And because of the issues discussed above, providing assistance for the healing process of pressure injuries in the buttocks area while in the seated position is much more complex than in the supine position. This likely explains why during the last decade hundreds of “seating and positioning” clinics emerged throughout the country, most of them attached to hospitals, specializing in solving problems related to pressure injuries in the buttocks area.

A study published in Europe in 2011 teaches that the average distance between the ischial tuberosities is 12.4 cm (4.88 inches), the minimum distance measured is 9.5 cm (3.74 inches) and the maximum is 15.5 cm (6.1 inches). The distance variation between the ischials is an important factor to be taken in consideration when planning the removal or reduction of the interface pressure from the sites of the ischials tuberosities. Similar consideration should be given to the possibility of a frail seated patient with an open wound in the coccyx, sliding forward from his/her original position.

The most important factor in the development of a pressure ulcer is unrelieved pressure. Therefore, a crucial requirement for the healing of an existing pressure injury is the complete removal of pressure at the site of the sore or, at least reduction of the interface pressure to under the threshold for capillary pressure for as long as the duration of the healing of the wound is not thoroughly completed. Scholars and investigators agree that pressure injuries are caused primarily by pressure and are treated with pressure removal. Thus, the very first step in treating a pressure sore at any stage is removing or relieving the pressure that caused it. Cyclical pressure on an existing injury caused by alternating pressure systems support system holds back the healing process of the open wound and should be avoided by all means.

Cyclical pressure on an existing injury caused by alternating pressure systems holds back the healing process of the open wound and should be avoided by an individual with open wounds in the sacrum/coccyx or ischia area when seated in a chair or a wheelchair.

Passive cushions now being used in the market utilizing foam, gel, air pockets or contour cushions may reduce the pressure on the bony parts of the buttocks but are unable to eliminate the pressure or lower it below the threshold for capillary pressure. Passive cushions provide comfort but do not prevent the creation of pressure sores nor do they remove the pressure from the site of an existing pressure sore enough for continuous healing. Independent studies show that best passive cushions reduce capillary pressure to around 60 mmHg (or higher). Long periods of low pressure are equally as damaging to the skin as short periods of high pressure. That is why individuals at risk seated on passive cushions are required to perform “lifts-and-shifts” frequently. Pressure relief movements while seated, however, require good upper-limb strength, which is often absent in the frail elderly and the physically disabled at high risk for developing pressure sores.

Existing systems for powered area support surfaces, and more particular regarding wheelchair cushions, often teach the use of an alternating pressure method of operation. One single exception is U.S. Pat. No. 6,560,803 (Zur) that teaches the control of individual air cells for the prevention of pressure sores formation. Most, but not all, of these alternating pressure wheelchair cushions use long, lateral, tubing types of air compartments divided in two groups: one group composed of interconnected odd cells, the other composed of the interconnected even cells. Some systems replace the lateral tubing with multiple, vertically placed air cells, but in both cases, the tubes or the air cells are divided in two interconnected groups operating in unison- one group inflates while the other group deflates. If properly deflated to a level that the applied pressure is less than the capillaries pressure, the person seated would actually be supported by only half of the cushion surface and the interface pressure, already very high in the seated position, would double, causing discomfort and a very high risk for skin breakdown. For this reason, alternating pressure systems avoid complete deflation that would separate the deflated compartments from the body seated on the cushion and the pressure at the bony parts of the buttocks remains higher than the capillary pressure. For the healing of existing pressure sores, alternating pressure methods also has negative effect on the healing process by the constant cyclical increase and decrease of pressure they apply on the wound.

Avoiding the interruption of the healing process of existing pressure injuries and actually assisting in the healing process may be achieved by:
(a) reducing the pressure at the location of the wound below the capillary pressure;
(b) maintaining the interface pressure at the location of the wound permanent and steady lower than the capillary pressure for as long as the healing process lasts; and
(c) minimizing secondary contributory factors such as friction and shear forces in the close vicinity to the open wound.

For healing an existing pressure injury, the removal alone of pressure below the open wound is, in effect, forbidden by professionals and by NPUAP and the European and Pacific international institutes. It creates the “donut effect” which generates friction and sheer forces, the second most important factors for skin breakdown and formation of pressure injuries. Minimizing the donut effect requires the control of the inner pressure in the individual cells circa the deflated cell, the gradual increase of inner pressure in the second and third rounds of cells and the measuring and reflection of the pressure on the controller's screen for the clinician to make corrections as needed.

Unlike pressure injuries which might be life threatening, spinal misalignment cause, in most cases, pain and breathing problems but are not life endangering. It is estimated that about 7 million Americans suffer from spinal abnormalities. Tall and thin girls aged 8 to 14 comprise the majority of early stage scoliosis cases. The risk of progression increases dramatically as the curvature of the spine is higher but it stops as skeletal maturity is reached. The only effective treatment offered are back braces for children prior to maturity and spine surgery.

People confined to wheelchairs often are left for long periods of time without routine check-ups by clinicians until a pressure injury stage 1 or 2 develops on their buttocks. Early stages of pressure injury lead to more severe cases and close follow-up on high risk patients is essential. This is where telemedicine may be of great service to the individuals and the health system.

Accordingly, a new and useful system that creates optimal conditions for continuous healing existing pressure ulcers in the buttocks area while an individual is in the seated position, and that may assist people with spinal abnormalities to alleviate pain and breathing problems, is desired

### SUMMARY OF THE INVENTION

The present disclosure describes an area support surface seating system suitable to provide localized external pressure relief for seated user that employs a pneumatic, computer controlled area support surface having a plurality of independent, vertically mounted inflatable air cells. A power supply system that includes a selector valve is operatively connected to the plurality of cells through the selector valve. The supply system also includes as control circuitry a printed circuit board (“PCB”) with a pressure sensor and a micro-processor in communication with a wireless control device. A Bluetooth low energy interface may be employed to facilitate communication between supply system and the wireless control device.

The area support surface of the system has a cushion base with a low elevation surface upon which the plurality of independent air cells is mounted. A grid of tubes located under the low elevation connects each air cell to the selector valve in the supply system. A second, higher elevation on the cushion base contains the supply system. The supply system, which also includes a compressor and a rechargeable battery as a power source, operates to selectively inflate and deflate either a single air cell or a group of air cells. A flash memory chip may be installed on the PCB so as to allow the computer controlled area support surface seating system to collect, store and send the data for printing or analysis by the clinician to ascertain the treatment designed for the patient.

The wireless control device, which may be a smartphone or other tablet, provides a user control interface that allows for a user to selectively adjust the internal pressure to each individual air cell. The wireless control device, continually retrieves data from the pressure sensor and displays upon request a mapping of the internal pressure for each individual air cell in the support surface. Accordingly, the wireless control device allows a clinician to address each individual air cell in order to determine its level of inflation and the duration of deflation.

It is an object of the present invention to eliminate or reduce the interface pressure to under the capillary pressure at the site of an open (or pressure related) wound and to provide an ability to control the pressure in each one of the air cells in vicinity to the deflated cell and thus minimize the effect of friction and shear force on the wound.

It is another object of the present invention to compensate for the loss of equilibrium caused by misalignment of the spinal cord by disproportionally inflation of the right and left sides of the area support surface, thus controlling the progression of the spinal cord misalignment at early ages and alleviating pain at later ages

It is another object of the present invention to maintain a constant exchange of information, to provide feedback between the pressure sensor and an external controller, and to display the result on the screen of the controller, so as to enable the collection, storage, and transmission of such the data to the clinician by means of remote communication.

These and other objects and advantages will be apparent to one of skill in the alt

### BRIEF DESCRIPTION OF THE DRAWINGS

FIG. 1 is a top plan schematic view of an area support surface seating system built in accordance with a uniform cylindrical air cell embodiment of the present disclosure.

FIG. 2a is a side perspective view showing underneath the top surface of a cushion base of an area support surface of the area support surface seating system built in accordance with an embodiment of the present disclosure.

FIG. 2b is a bottom perspective view of the top surface of the cushion base of the area support surface of the area support surface seating system built in accordance with an embodiment of the present disclosure.

FIG. 3 is a side perspective view showing the top of the top surface of the cushion base of the area support surface of the area support surface seating system built in accordance with an embodiment of the present disclosure shown with four air cells in place thereon.

FIG. 4 is a schematic of an air supply system for the area support surface seating system built in accordance with an embodiment of the present disclosure.

FIG. 5 is a block diagram showing the electrical and control systems of the area support surface seating system built in accordance with an embodiment of the present disclosure.

FIG. 6 is a schematic of a printed circuit board of the area support surface seating system built in accordance with an embodiment of the present disclosure.

FIG. 7a is a top plan schematic view of the area support surface seating system built in accordance with an enlarged lateral oval cell embodiment of the present disclosure.

FIG. 7b is a top plan schematic view of the area support surface seating system built in accordance with an enlarged lateral oval rectangular cell embodiment of the present disclosure.

FIG. 8a is a top plan schematic view of the area support surface seating system built in accordance with an enlarged longitudinal oval cell embodiment of the present disclosure.

FIG. 8b is a top plan schematic view of the area support surface seating system built in accordance with an enlarged longitudinal oval rectangular cell embodiment of the present disclosure.

FIG. 9 is a top plan schematic view of an area support surface seating system built in accordance with a uniform rectangular air cell embodiment of the present disclosure

FIG. 10 shows the front of a wireless control device of the area support surface seating system built in accordance with an embodiment of the present disclosure.

FIG. 11 is a top plan schematic view of the area support surface seating system built in accordance with a uniform air cell embodiment of the present disclosure, shown with an exemplary level of inflation, in PSI figures, for the array of cells used in connection with the existence of a pressure sore at the left ischial tuberosity of the individual seated on the cushion.

### DETAILED DESCRIPTION OF THE INVENTION

Applicant's area support surface seating system described herein provides for localized pressure relief for seated user in the form of a cushion for a wheelchair or other support for a seated user. The area support surface seating system is capable of optimizing conditions for a seated user to avoid interrupting the healing of pressure injuries in the area of the buttocks as well as to restrain the progress of spinal deformities while the user is in the seated position.

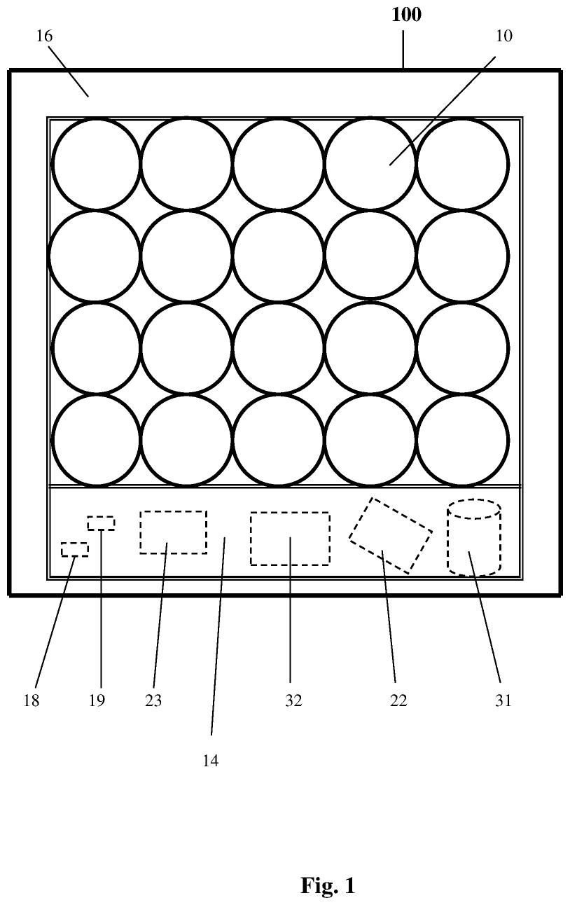

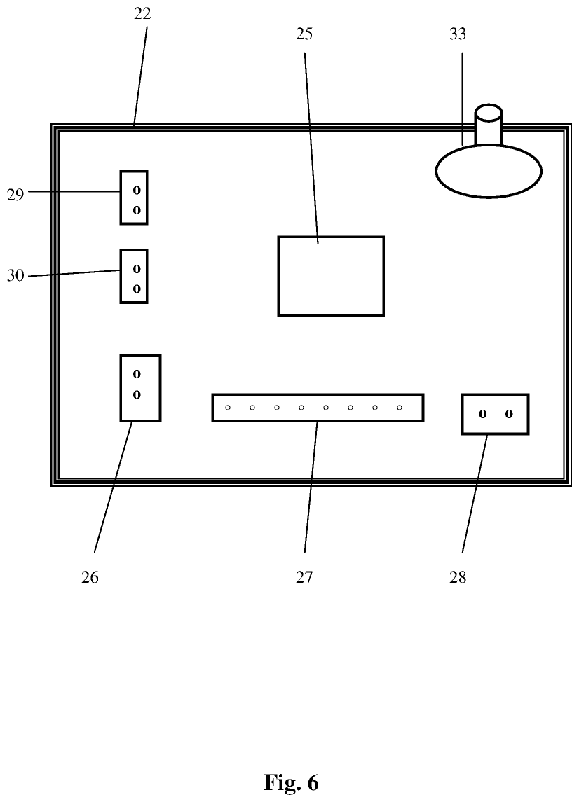

Referring now to the drawings and, in particular, to FIGS. 1, 2a, 2b, 3, 4, 5, 6, 7a, 7b, 8a, 8b, and 10, an area support surface seating system in accordance with the present disclosure is shown having a cushion base 13 that includes a plurality of independent, inflatable air cells 10, a power supply system 20 and an external wireless control device 40. In a uniform cylindrical air cell embodiment, the area support surface 100 includes an array of identical, substantially round in cross section, tubular in shape air cells 10, vertically mounted on the cushion base 13 in close proximity to each other. The inflatable air cells 10, forming the support adjustment aspect of the cushion, may be produced from soft, non-stretchable air-tight fabric.

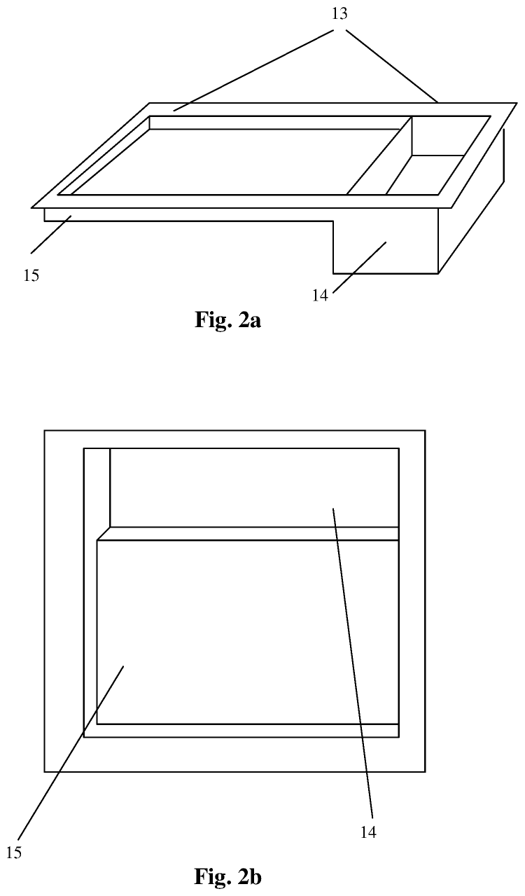

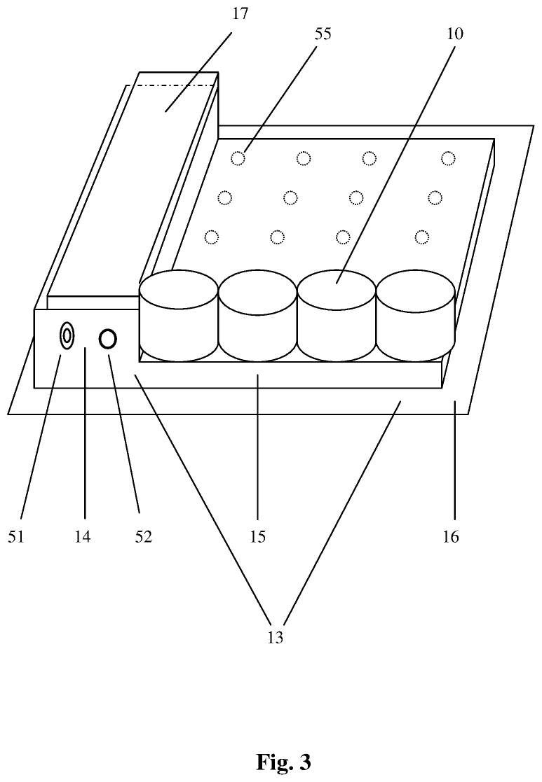

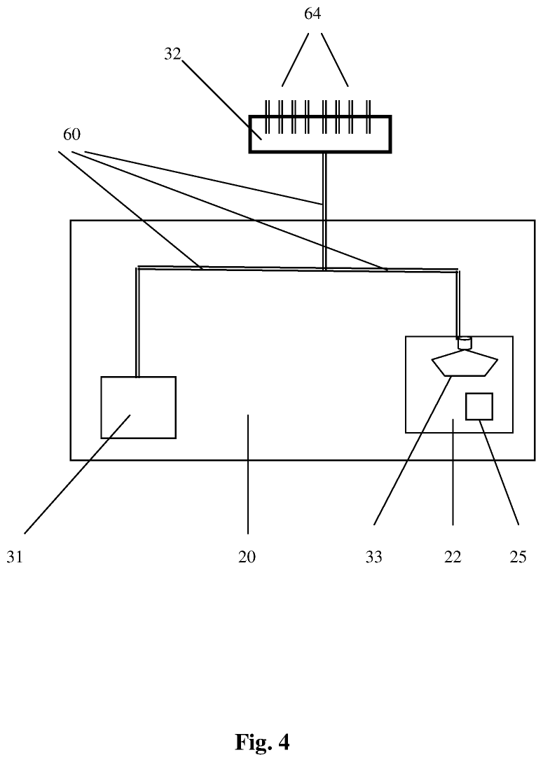

As illustrated in FIGS. 2a and 2b, the bottom of the cushion base 13 may be vacuum formed using acrylonitrile butadiene styrene (“ABS”) or comparable material with similar toughness and resistance attributes. The cushion base 13 may have a lower elevation 15 on which a plurality of inflatable air cells 10 are vertically mounted, as shown in FIG. 3, and a higher elevation 14 within which the components of supply system 20 as detailed in FIG. 4 are placed. A flat layer of ABS or similar material (not shown) is attached with screws and bolts under the cushion base 13 to seal the elements of the supply system 20 within the higher elevation 14 of base 13 and the tubing 64 connecting the air cells to the supply system 20 within the lower elevation 15 of cushion base 13. As shown in FIG. 3, the lower elevation 15 of the cushion base 13 has holes 55 to allow the tubing 64 from the selector valve 32 to connect to each air cell 10. The holes 55 are placed at intervals that ensure close proximity between cells 10 sufficient to provide lateral support to each other when inflated.

The cushion base 13 is built with a lower ledge 16 on all four sides of the base, as shown in FIG. 3, which may serve to allow for the attachment of the top surface of the cushion base 13 with a bottom surface of the cushion base 13, which may be defined by a flat sheet of the same material, with screws and bolts. The ledge 16 supports a vertical foam frame (not shown) shaped to conform the size of the chair upon which area support surface 100 is placed and the height of the cells 10 when inflated. The foam frame encloses the entire surface of the area support surface 100 including the high elevation 14. A thin flat layer 17 of foam, also shown in FIG. 3, is placed over the high elevation 14 of the base 13 to level elevation 14 with the inflated air cells 10. While in use, area support surface 100 is to be oriented so that the elevation 14 is closes to the front of a chair, positioned under the thighs of the seated individual. It is contemplated that the size of the area support surface 100 and the number of air cells might vary to accommodate differences in individual's weight, size or diverse uses of the support surface. The entire cushion base 13 is enveloped in a cover of which the upper portion is made of soft, stretchable, impermeable fabric and the bottom portion is made of non-skidding material.

The inflatable air cells 10 are made of light, soft, non-stretchable fabric. A ring of ABS or similar material may be placed and sealed inside the cell at the bottom to prevent the cell from ballooning when fully inflated. Each air cell 10 has an opening in the bottom in which a rubber or plastic fitting is inserted and sealed to the fabric of the cell 10. The fittings at the bottom of the respective cells 10 extend through holes 55 in base 13 to connect each respective cell 10 to the corresponding respective tube 64 from the selector valve 32. The grid of tubes 64 connecting the selector valve 32 to each individual air cell 10 is placed under the matrix of air cells 10 in the space of the low elevation 15.

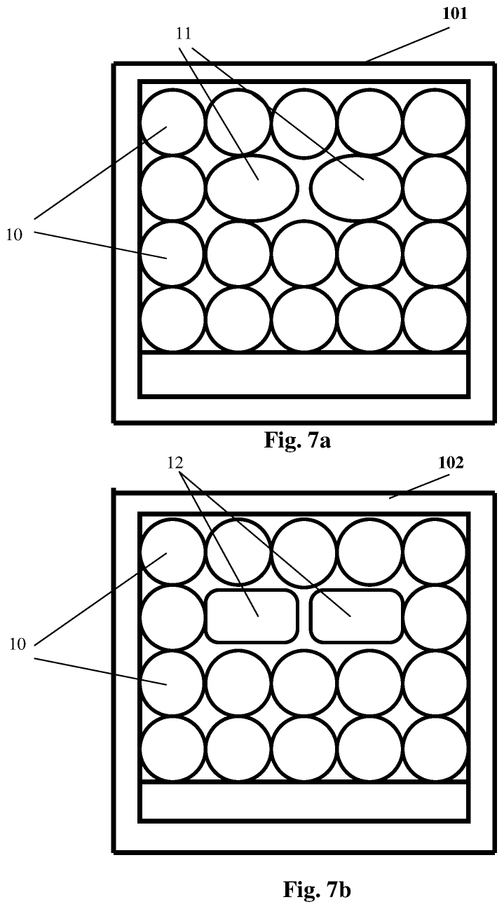

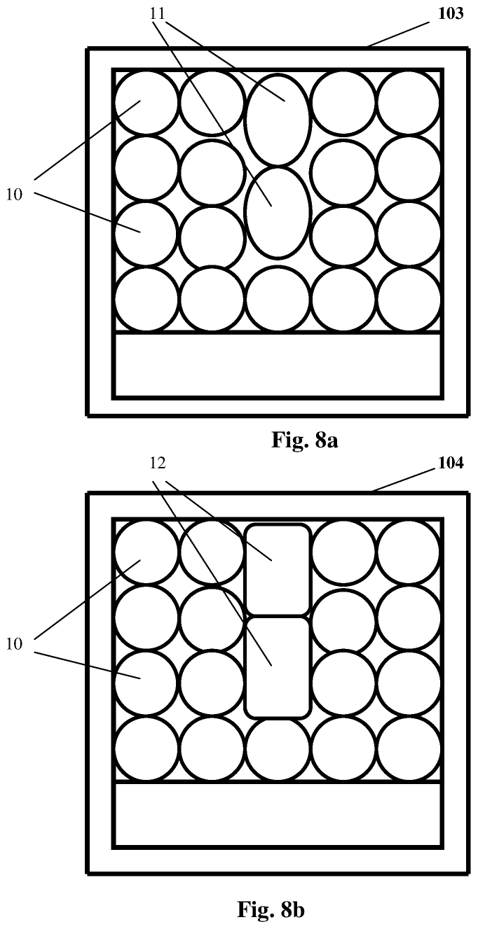

In some embodiments of the present invention, the size, shape and amount of air cells in the support surface of the seating system may be of varying sizes and shapes in effort to promote healing in accordance with the method described below, including but not limited to round cells 10, specifically positioned oval cells 11 or specifically positioned rectangular cells 12, shown in FIGS. 7a, 7b and 8a, 8b. Indeed, the size of the seating support surface and the number of air cells might vary to accommodate different individual's weight, size or diverse uses.

The most common location in the buttock area for the formation of pressure injuries are the ischial tuberosities. As previously mentioned, the average distance between the two ischial tuberosities. is 12.4 cm (4.88″). The size of cells 10 in the preferred embodiment is calculated to correspond to the most common distance between the ischial tuberosities. FIGS. 7a and 7b show the use of oval cells and rectangular cells respectively in the location of the ischials when needed because of the distance between the ischials of the individual treated being shorter or larger than the average.

FIGS. 7a and 7b show an embodiment of an area support surface 101 having laterally positioned oval air cells 11 and an embodiment of an area support surface 102 having laterally positioned rectangular air cells 12, respectively, each in close proximity to accommodate shorter distance between the ischial tuberosities. Similarly, if the distance between the ischial tuberosities is significantly bigger than the average, the two respective oval cells 11 or rectangular cells 12 may be placed further away from each other with a round cell 10 between them.

The coccyx (tail bone) is another common spot for the formation of pressure sores. Frail people tend to slide down in their seat. Thus, if the individual treated has an open wound or is at a very high risk of developing a pressure injury at the coccyx location, oval cells or rectangular cells might be used as shown in FIGS. 8a and 8b, respectively. To secure a no-pressure area under an existing wound in the coccyx area substantially at all times, an embodiment of an area support surface 103 having longitudinally positioned oval air cells 11, as illustrated in FIG. 8a, or an embodiment of an area support surface 104 having longitudinally positioned rectangular air cells 12, as illustrated in FIG. 8b, may be employed. It is appreciated that with the enlarged air cells positioned longitudinally in the middle of the support surface, a larger area that corresponds to an area of high risk can be addressed more quickly. It is noted, however, that enlarged air cells may be of any shape or pattern as long as the at least one cell positioned under the injury provides an interface pressure below the capillary pressure while the cells adjacent thereto may be set to provide a gradual increase or decrease as described below.

The pneumatic supply system, as shown in FIG. 4, includes the supply system 20 placed in the space created by the high elevation 14. The supply system 20 includes a mini compressor 31 for use as an air pump, a selector valve 32 that connects, via tubes 64, between the compressor 31 and the air cells 10, and a PCB 22 with a micro-processor 25 and a pressure sensor 33. Tubes 60 connect between the compressor 31, the pressure sensor 33 on the PCB 22, and the selector valve 32 so that the pressure in whichever air cell open on the selector valve can be measured by the pressure sensor 33. Operating in conjunction with the supply system 20 are two speakers: speaker 18 is activated when a bottoming out occurs within an air cell 10 and speaker 19 is activated when a new parameter is set for the supply system 20 as described below.

It is contemplated that the compressor 31 may be an off-the-shelf item. Consideration is given to the size, power, noise and vibration, quality and price. In some embodiments, if the noise or vibration is too high, the compressor 31 may be located outside of the cushion base 13 in a separate case, with improved sound barrier, connected to the rest of the system by quick connectors.

It is contemplated that the pressure sensor 33 and the selector valve 32 may also be off-the-shelf items. The selector valve 32 will have plurality of channels to provide the best and most cost-effective results of the treatment. A tube 64 may provide pressurized air to a single air cell 10 and/or two or more air cells 10. For each channel, the selector valve 32 has three positions: open to receive air to the selected air cell; open to release air from the air cell to the atmosphere; and closed to maintain the pressure state of the selected cell. The opening and closing of the selector valve 32 channels, as well as the operation of the compressor 31 and pressure sensor 33 and the order and sequence of the operation is directed by the microprocessor 25.

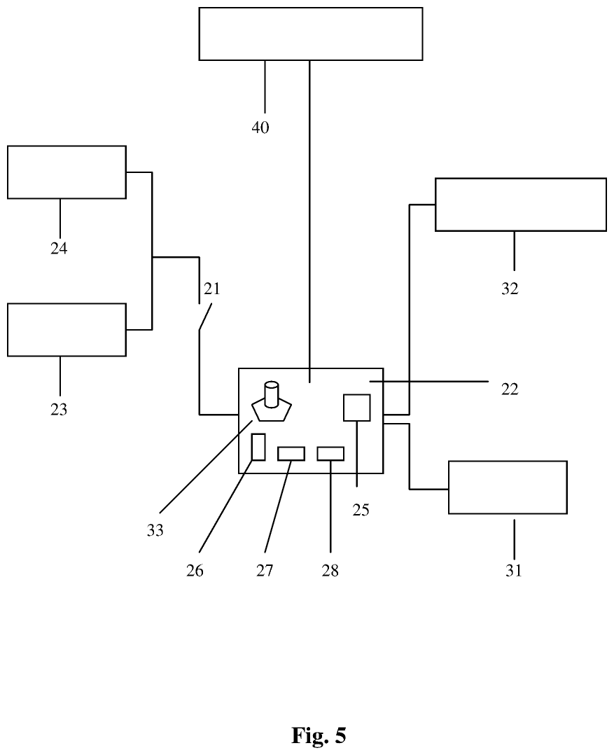

FIG. 5 shows a diagram of the power supply system and the interaction between its components and the pneumatic system parts. The area support surface 100 may operate on a 12V power supply. The power to activate the pneumatic system's components when mobility is needed is provided by the rechargeable 12V battery 23. The 12V battery 23 is charged by the external A/C adaptor 24 through a connector 52 and is the source of power that ordinarily operates the system while an individual uses the area support surface 100. The battery 23 is placed within the supply system 20, as shown in FIG. 1, and it ideally will be powerful enough to last at least 12 hours of operation before it needs to be recharged. As shown in FIG. 3, the cushion has an ON/OFF switch 51 that connects or disconnects the battery 23 from the rest of the supply system 20 components to prevent current leakage from the battery 23 and keep it charged when the system is not in use.

The PCB 22 has a connector 26 to the compressor 31; a connector 27 to the selector valve 32; a connector 28 to the battery 23; a connector 29 to the speaker 18 that provides an audio alarm signaling that a bottoming out condition has occurred and a connector 30 to the speaker 19 that audio signals when any parameter of operation (such as inflation level of an air cell or duration of an air cell deflation prior to an automatic change) is set or changed. The PCB 22 also has the pressure sensor 33 and the microprocessor 25.

The microprocessor 25 may be an off-the-shelf item encoded to communicate with the wireless control device 40, receive the information pre-set by the clinician in the wireless control device 40 and execute the program coordinating the operation of the supply system elements.

When a channel in the selector valve 32 is in the position open for air flow to cell 10, the pressure sensor 33 measures the combined pressure in tube 66 and the respective cell or group of cells 10 that are associated with the open channel. As the pressure reaches the level preset in the program, the pressure sensor 33 signals the microprocessor 25 which in turn signals to the selector valve 32 to switch this channel to the close position and signals the compressor 31 to cease pumping air. At the same time, the microprocessor 25 signals the selector valve 32 to open another channel to release air from its respective cell 10 or group of cells 10 to the atmosphere. As long as this line is open for the release of air to the atmosphere, there is no resistance in this line and therefore pressure does not build up in the cell or group of cells associated with this channel. After a preset duration of time, the micro-processor 25 signals the selector valve 32 to turn this line to the position of re-inflation (open for air flow to the cell), signals the compressor 31 to pump air and the selector valve 32 to open another line for deflation. The cycle continues according to the program set by the clinician using the external wireless control device 40.

In another embodiment of the present invention, the supply system is located in a separate case outside the cushion with a quick connector for the air supply system and another quick connector for the electrical system. In another embodiment of the present invention the air pump alone is located in a separate case outside the cushion with air supply and electrical quick connectors. In another embodiment of the present invention where there is enough space under the plurality of air cells such as in a bedside chair, or a home or office chair, the base is uniformly elevated to be covered on its entire surface with air cells 10 and all the elements of the supply system 20 are placed underneath the layer of air cells along with the grid of tubing 64. Other embodiments of the present invention where a larger cushion is required, such as chairs and wheelchairs for obese people, the support surface may be comprised of larger cells 10 or an increased number of cells 10.

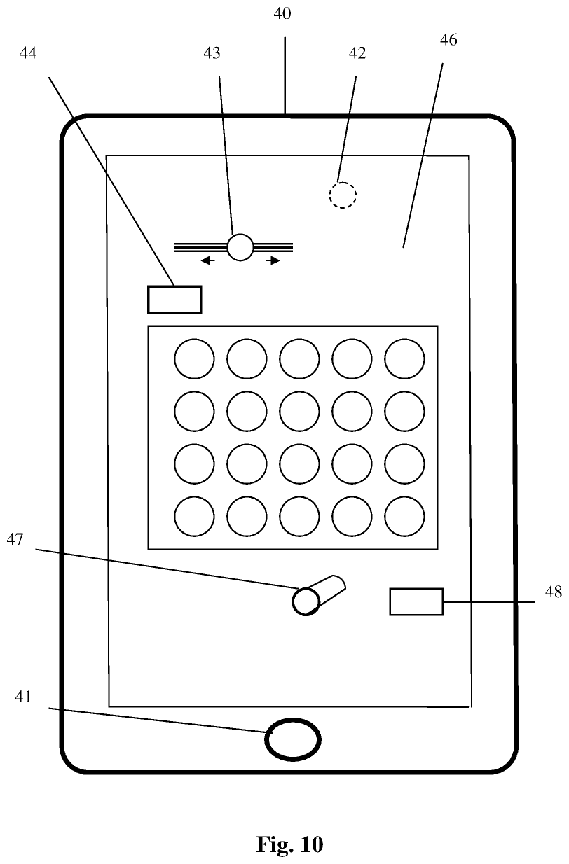

The area support surface system may be operated and controlled using an external wireless control device 40 that uses Bluetooth low energy connectivity, such as a smart phone or a tablet. As illustrated in FIG. 10, a button 41 may be used to turn the wireless control device 40 on or off. A connection 42 shows whether the wireless control device 40 is communicating with the microprocessor 25. As a deflation time window 44 illuminates, the wireless control device 40 sets the deflation time selected for the respective individual treated, by moving a slider 43 right and left and press “set” at window 48. A touch screen 46 enables the operator to choose and mark a cell 10 on the screen and select, again by moving the slider and pressing “set” when the maximum pressure allowed for this particular cell 10 or group of cells 10 is affixed. After selecting a maximum pressure level and duration of deflation for each cell 10 or group of cells, pressing “set” window 48 will cause the data selected by the program to be stored. The area support surface system then operates in accordance with the stored parameters.

The inflation pressure can be selected in intervals most desirable by the clinicians. In the preferred embodiment of the present invention the inflation pressure is selected in intervals of 0.25 PSI for all cells or groups of cells in the area support surface, by pointing to the cell on the screen 46, moving the slider 43 to the selected level of inflation and pressing the set button 48 when done. The duration of the deflation can be set between 1 and any number of seconds when touching window 44, using the slider to choose the desired figure and pressing the set window 48.

A software application for operating the area support surface system may be embedded in the micro-processor 25. An operator may use the wireless control device 40 to choose the features most suitable to the patient treated and conveys them to the micro-processor 25. The micro-processor processes the new data and transmits operating parameters to the various components of the supply system 20, including the compressor 31, the selector valve 32 and the pressure sensor 33.

Those skilled in the art will also appreciate the ability of the system to create higher pressure in one side and lower pressure in the other side of the support surface in order to compensate for the pressure produced by the spine misalignment, especially by individuals with C curvature in their spine. Taking this preventive measure at early stage of spinal deformity during school time and homework at home, might reduce the chance of progression of a curvature that exceeds 20 degrees at the risky age from 68 percent to a much lower level.

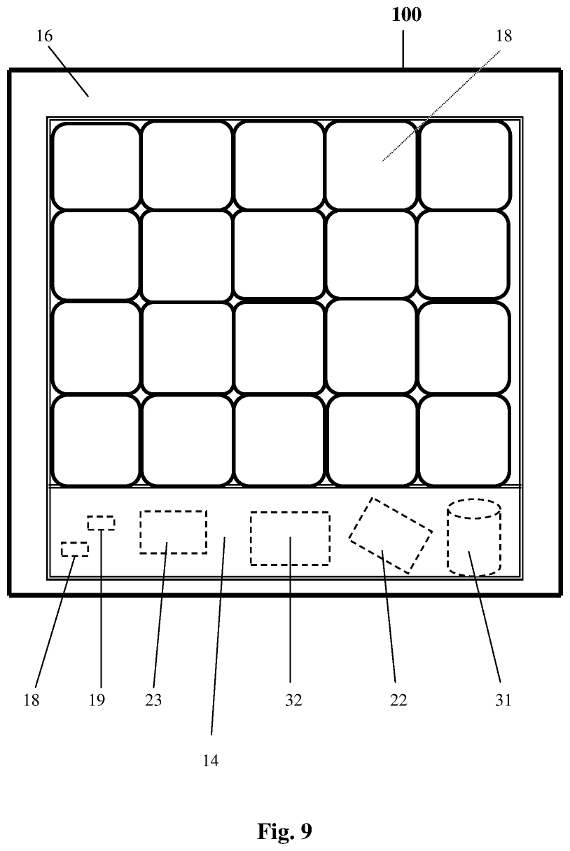

As illustrated in FIG. 9, a uniform rectangular air cell embodiment of the cushion base is similar to the uniform cylindrical air cell embodiment except that it includes a of identical, substantially rectangular in cross section, prism shape air cells 18, vertically mounted on the cushion base 13 in close proximity to each other.

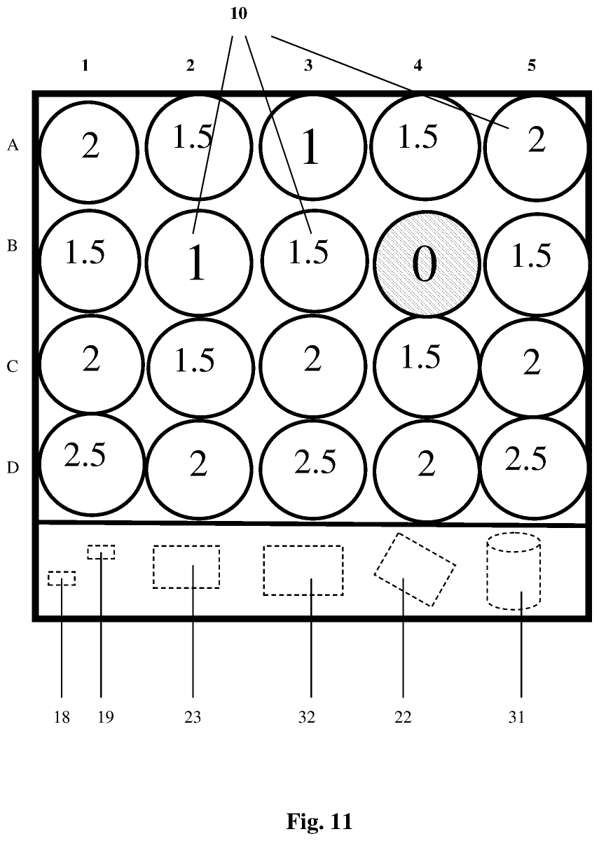

Referring now to FIG. 11, an example of a maximum pressures set for the matrix of air cells comprising the area support surface is shown. As illustrated in FIG. 11, the pressure in cell 10 number B4 (Row B, Column 4) that corresponds to the left ischial of the seated person is set to zero. That means that this cell is closed to the flow of air from the compressor 31 via the selector valve 32 and is kept open to the atmosphere. The inner pressure of the cell 10 under the right ischial tuberosity (B2) is set to 1 PSI to maintain minimal equilibrium of the body. The inner pressure in the cells further away from both the left and right ischial tuberosities is gradually increased to a maximum support pressure as we move further away from the lower pressurized cells 10 to minimize secondary factors such as shear and friction affecting the formation of pressure injuries yet avoiding bottoming out.

In the case of an existing pressure sore at the ischial tuberosity on the right side of a seated user, air cell B2 that corresponds to the right ischial tuberosities of the seated person is set to zero and cell B4 is set for minimal inflation of 1 PSI. In the rare case of existing pressure sores on both sides of the ischial tuberosities, cells B2 and B4 would both be set for zero. The inflation level of the remaining cells may have to be increased or decreased to avoid bottoming out, depending on the size and the weight of the individual being treated.

The relative pressure of each cell 10 is displayed with a number; in example being one of substantially 0, 1, 1.5, 2, and 2.5 PSI in a preferred non-limiting example. In an embodiment, the maximum air pressure allowed at any cell 10 may be 2.5 PSI. But in actuality, maximum pressure is limited only by the manufacturing tolerances of the materials of cell 10. Relatively lower pressures of 1 and 1.5 PSI are adjacent to the zero-pressure cell 10, and pressure is gradually increased as the cells 10 are farther away from the sore and the corresponding zero pressure cell 10. This provides a gradual interface pressure gradient from a target location of the zero-pressure cell 10 for reducing friction and shear forces applied to the skin of the buttocks of the individual seated on the cushion.

By utilizing a cushion constructed in accordance with the present invention, it becomes possible to selectively address individual inflatable cells within the array of cells to create an area at a target location which may be free of interface pressure at the site of an open wound on the buttocks, thus setting up the conditions for not tampering with the healing process of the wound. As a result of the unique structure of the present invention, the damaging intermittent pressure on a wound, which is a result of the prior art devices, may be eliminated. Because of the ability to embed a variety of patterns for individually addressed cells, it is possible to provide constant low pressure at a wound site, to avoid exceeding a desired healing pressure. Furthermore, optimum conditions may be created by an accredited user for faster healing of an open wound on the buttocks by providing a no pressure area under the wound while the rest of the support surface consisted of the remaining cells 10 performs a preventive protocol to avoid the development of new pressure sores.

Furthermore by providing an array of independent air cells, the resulting structure allows for the control of inflation and deflation of one cell at a time or a group of cells acting together at a time or both. In an embodiment, two of the active (non-deflated) cells may be inflated/deflated at a time, one on each side of the buttocks, for the purpose of maintaining equilibrium of the body seated. Deflating two out of, for example, twenty cell support surface makes very little difference, if at all, in comfort or in the increase of inner pressure required in the inflated cells. Furthermore, because the cells are operated independently, a zero-interface pressure can be produced at more than one location within the cushion if necessary to help heal more wounds. At the same time, even if no sores are present, the remaining area of cushion may operate in the prevention mode.

The system described herein also allows the clinician to personalize the preventive protocol to compensate for the persons weight and the severity of the risk for pressure sores. It allows the clinician to choose the rate of inflation between 1.5, 2 and 2.5 PSI and the duration of rest in the deflation mode from 0 seconds to any number.

Attaining a zero-interface pressure area between the cushion air cell and the sore under the open wound results in:
a. Providing optimal conditions for healing by not obstructing blood flow to the open wound or affecting the wound with cyclical alternating pressure.
b. eliminating the essential “lifts and shifts” which in most cases require the assistance of another person.
c. providing a synergistic effect to other existing wound treatments such as creams and ointments.

The function of the support surface is controlled by the clinician using an electronic device such as a smart phone, a tablet or a handheld computer. It allows to:
a. choose the air cell under the open wound to maintain it open to the atmosphere and have the interface pressure reduced to zero pressure
b. set a lower level of inflation to the surrounding air cells in order to provide a gradual pressure gradient around the wound, minimizing forces which tear the skin adjacent to the wound
c. set the level of inflation for all other air cells to avoid bottoming out
d. set the duration of the time off in the deflation mode.
e. set the level of inflation in a non-limiting embodiment to vary from zero pressure up to 2.5 PSI in increments of 0.25 PSI, thus compensate for the weight of the body supported and assure that no bottoming out occurs.
f. set the time off in the deflated cycle in increments of 1 second from 2 up to 30 seconds or even more, depending on the severity of the wound and the purpose of the treatment. The shorter times increase the massage effect and the blood flow, while the longer times allows an increase supply of oxygen and nutrition to the risky parts of the body preventing sore creation in the first instance.

The ability to control the present invention through a smartphone or a tablet, with the wireless communication and the constant exchange of information and feedback between the pressure sensor, the microchip and the external controller, enable area support surface system in accordance with the present disclosure to be ready to be used for telemedicine, thus saving resources for the patients, providers and the entire medical system.

It will be understood that many additional changes in the details, materials, steps and arrangement of parts, which have been herein described and illustrated to explain the nature of the invention, may be made by those skilled in the art within the principle and scope of the invention as expressed in the appended claims.

1. An area support surface seating system, comprising:
a cushion base having a top surface and constructed of a rigid material, wherein said top surface is defined by at least a lower elevation section, a higher elevation section, and a lower ledge, with said lower ledge being positioned on a distinct plane relative to the lower elevation section and the higher elevation section;
wherein said cushion base includes a hollow space underneath the higher elevation section and above the plane of the lower ledge;
wherein said lower ledge extends outwardly from and completely around a combined perimeter of the lower elevation section and the higher elevation section so as to enclose both the lower elevation section and the higher elevation section;
a support adjustment aspect adapted to receive the buttocks of a user that is seated and modulate pressure on the regions of the buttocks of a user subject to substantially all of the pressure created by the upper body of a user, wherein said support adjustment aspect is defined by a plurality of discrete, inflatable air cells which may be inflated and deflated independently, each mounted directly on the top surface on the lower elevation section;
a power supply system integral with said cushion base and connected to each of the air cells, wherein said power supply system is configured to selectively direct fluid material into each of the air cells individually, selectively cause fluid material to be released from each of the air cells individually, selectively seal each of the air cells individually such that fluid material cannot go in or out, and measure the internal pressure for each of the air cells individually;
a discrete control device having at least one user interface and configured to communicate electrical signals with the power supply unit wirelessly, wherein said control device is configured cause the power supply system to modify parameters of the support adjustment aspect by selectively directing fluid material into one or more selected air cells among the plurality of air cells, selectively causing fluid material to be released from the one or more selected air cells, and selectively sealing the one or more selected air cells based on input received through the at least one user interface; and
wherein said control device is additionally configured to generate on the at least one user interface a real time visual output related to internal pressure of each of the air cells from the measurements of the power supply system and allow internal pressure for a plurality of intended air cells among the plurality of air cells to be selectively adjusted based on a spatial proximity of each the plurality of intended air cells to a target location that is defined by one or more zero internal pressure air cells among the plurality of air cells such that there is an incremental increase in internal pressure among the plurality of intended air cells as spatial proximity from the target location increases, thereby reducing friction and shear on the skin of a user adjacent to the target location.

2. The area support surface seating system of claim 1, wherein said control device is configured to enable selective modification of parameters of the support adjustment aspect while a user is seated so as to cause a reduction in interface pressure at a target location on the support adjustment aspect.

3. (canceled)

4. The area support surface seating system of claim 1, wherein said power supply system includes at least a power source, control circuitry, a pressure sensor, a selector valve, and a pump.

5. The area support surface seating system of claim 4, wherein at least said control circuitry, pressure sensor, selector valve, and pump are positioned in the hollow space under the higher elevation section.

6. The area support surface seating system of claim 4, wherein the pressure sensor of the said power supply system is configured to uninterruptedly measure the pressure in one or more specified air cells among the plurality of air cells that are open to receive fluid material, the power supply system is configured to store data from the measurements of the pressure sensor, and the real time visual output of the control device reflects the measurements of the pressure sensor.

7. The area support surface seating system of claim 1, additionally comprising at least one speaker that is electrically connected to the power supply system and operative to generate an audible alert in response to an electrical signal from the control circuitry that is generated when a bottoming out condition is created in the cushion base.

8. The area support surface seating system of claim 1, additionally comprising at least one speaker that is electrically connected to the power supply system and operative to generate an audible alert in response to the modification to parameters of the support adjustment aspect operation.

9. The area support surface seating system of claim 1, wherein at least one of said plurality of air cells has a round cross section and the at least one of said plurality of air cells having the round cross section includes a rigid ring sealed inside and disposed at a bottom of the at least one of said plurality of air cells having the round cross section to prevent the at least one of said plurality of air cells having the round cross section from ballooning when fully inflated.

10. The area support surface seating system of claim 9, wherein each of said plurality of air cells is identical in size and shape.

11. The area support surface seating system of claim 1, wherein at least one of said plurality of air cells has an oval cross section.

12. The area support surface seating system of claim 9, wherein at least one of said plurality of air cells has a rectangular cross section.

13. The area support surface seating system of claim 1, wherein each of said plurality of air cells has a rectangular cross section.

14. The area support surface seating system of claim 1, wherein said power supply system is connected to each of the air cells through a plurality of flexible tubes which each run under the lower elevation of the base and pass through a hole in the lower elevation to connect to one of the air cells.

15. The area support surface seating system of claim 1, wherein a pair of target air cells which are among the plurality of air cells are (1) positioned in a location that corresponds to the ischials of a user and (2) enlarged relative to the other air cells in the plurality of air cells.

16. The area support surface seating system of claim 1, wherein a pair of target air cells which are among the plurality of air cells are (1) positioned in a location that corresponds to the coccyx of a user and (2) enlarged relative to the other air cells in the plurality of air cells.

17. The area support surface seating system of claim 3, wherein said lower ledge is positioned beneath the lower elevation section and the higher elevation section.

18. The area support surface seating system of claim 1, wherein a pair of target air cells which are among the plurality of air cells are (1) positioned in a location that corresponds to the ischials of a user and (2) enlarged relative to all of the other air cells in the plurality of air cells.

19. The area support surface seating system of claim 1, wherein a pair of target air cells which are among the plurality of air cells are (1) positioned in a location that corresponds to the coccyx of a user and (2) enlarged relative to all of the other air cells in the plurality of air cells.

20. The area support surface seating system of claim 7, wherein said power supply system is connected to each of the air cells through a plurality of flexible tubes which each run under the lower elevation of the base and pass through a hole in the lower elevation to connect to one of the air cells.

21. An area support surface seating system, comprising:
a cushion base having a top surface and constructed of a rigid material, wherein said top surface is defined by at least a lower elevation section, a higher elevation section, and a lower ledge, with said lower ledge being positioned on a distinct plane relative to the lower elevation section and the higher elevation section;
wherein said cushion base includes a hollow space underneath the higher elevation section and above the plane of the lower ledge;
wherein said lower ledge extends outwardly from and completely around a combined perimeter of the lower elevation section and the higher elevation section so as to enclose both the lower elevation section and the higher elevation section;
a support adjustment aspect adapted to receive the buttocks of a user that is seated and modulate pressure on the regions of the buttocks of a user subject to substantially all of the pressure created by the upper body of a user, wherein said support adjustment aspect is defined by a plurality of discrete, inflatable air cells which may be inflated and deflated independently, each mounted directly on the top surface on the lower elevation section;
wherein at least one of said plurality of air cells has a round cross section and the at least one of said plurality of air cells having the round cross section includes a rigid ring sealed inside and disposed at a bottom of the at least one of said plurality of air cells having the round cross section to prevent the at least one of said plurality of air cells having the round cross section from ballooning when fully inflated;
a power supply system integral with said cushion base and connected to each of the air cells, wherein said power supply system is connected to each of the air cells through a plurality of flexible tubes which each run under the lower elevation of the base and pass through a hole in the lower elevation to connect to one of the air cells, with the power supply system thereby configured to selectively direct fluid material into each of the air cells individually, selectively cause fluid material to be released from each of the air cells individually, selectively seal each of the air cells individually such that fluid material cannot go in or out, and measure the internal pressure for each of the air cells individually;
a discrete control device having at least one user interface and configured to communicate electrical signals with the power supply unit wirelessly, wherein said control device is configured cause the power supply system to modify parameters of the support adjustment aspect by selectively directing fluid material into one or more selected air cells among the plurality of air cells, selectively causing fluid material to be released from the one or more selected air cells, and selectively sealing the one or more selected air cells based on input received through the at least one user interface;
at least one speaker that is electrically connected to the power supply system and operative to generate an audible alert in response to an electrical signal from the control circuitry that is generated when a bottoming out condition is created in the cushion base; and
wherein said control device is additionally configured to generate on the at least one user interface a real time visual output related to internal pressure of each of the air cells from the measurements of the power supply system and allow internal pressure for a plurality of intended air cells among the plurality of air cells to be selectively adjusted based on a spatial proximity of each the plurality of intended air cells to a target location that is defined by one or more zero internal pressure air cells among the plurality of air cells such that there is an incremental increase in internal pressure among the plurality of intended air cells as spatial proximity from the target location increases, thereby reducing friction and shear on the skin of a user adjacent to the target location.
